(19) United States
(12) Patent Application Publication
(10) Pub. No.: US 2008/0107197 A1
(43) Pub. Date: May 8, 2008

(54) Method and apparatus for setting transmission grant of a multi-input multi-output user equipment in a network of a wireless communications system

(75) Inventor: Yu-Chih Jen, Taipei City (TW)

Correspondence Address: BIRCH STEWART KOLASCH & BIRCH, PO BOX 747, FALLS CHURCH, VA, 22040-0747, US

(73) Assignee: Innovative Sonic Limited, Tortola (VG)

(21) Appl. No.: 11/979,688

(22) Filed: Nov. 7, 2007

Related U.S. Application Data
(60) Provisional application No. 60/857,187, filed on Nov. 7, 2006.
(60) Provisional application No. 60/864,962, filed on Nov. 8, 2006.
(60) Provisional application No. 60/857,803, filed on Nov. 9, 2006.

(51) Int. Cl. H04Q 7/32

(52) U.S. Cl. 375/260

(57) ABSTRACT

A method for setting transmission grant of a MIMO UE in a network of a wireless communications system for uplink transmission is disclosed. The method includes sending at least one control or configuration message corresponding to each HARQ entity of at least one HARQ entity or at least one HARQ process of an HARQ entity to the UE to set transmission grant of the UE when the UE performs uplink transmission through the at least one HARQ entity or the at least one HARQ process of the HARQ entity.

### CROSS REFERENCE TO RELATED APPLICATIONS

This application claims the benefit of U.S. Provisional Application No. 60/857,187, filed on Nov. 7, 2006 and entitled “Method and Apparatus for Realizing Uplink HARQ Operation with MIMO Technology”, the benefit of U.S. Provisional Application No. 60/864,962, filed on Nov. 8, 2006 and entitled “Method and Apparatus for realizing Uplink HARQ operation with MIMO technology”, and the benefit of U.S. Provisional Application No. 60/857,803, filed on Nov. 9, 2006 and entitled “Method and Apparatus for realizing Uplink HARQ operation with MIMO technology”, the contents of which are incorporated herein by reference.

### BACKGROUND OF THE INVENTION

1. Field of the Invention

The present invention relates to a method and apparatus for setting transmission grant of a multi-input multi-output user equipment in a network of a wireless communications system, and more particularly, to a method and apparatus for accurately setting transmission grant of the multi-input multi-output user equipment.

2. Description of the Prior Art

Multi-input and multi-output, or MIMO, refers to the use of multiple antennas both at the transmitter and receiver to improve the performance of a radio communications systems. MIMO technology has attracted attention in wireless communications, since it offers significant increases in data throughput and link range without additional bandwidth or transmit power.

Generally, MIMO technology can be classified into the following operating modes, including:

1. Spatial Multiplexing (SM): In the transmitter, a high rate signal is split into multiple lower rate streams and each stream is transmitted from a different antenna in the same frequency channel. SM is very powerful technique for increasing channel capacity at higher Signal to Noise Ratio (SNR).

2. Transmit Diversity (TD, or named spatial diversity): A single stream is received or transmitted though multiple paths established by multiple antennas, so that transmission quality can be enhanced.

3. Beamforming: When receiving a signal, beamforming can increase the receiver sensitivity in the direction of wanted signals and decrease the sensitivity in the direction of interference and noise. When transmitting a signal, beamforming can increase the power in the direction the signal is to be sent.

The above-mentioned operating modes can be used in coordination.

A new mobile communications system, such as Long Term Evolution (LTE) wireless communications system, is an advanced high-speed wireless communications system established upon the 3G mobile telecommunications system, and uses technologies of High Speed Downlink Package Access (HSDPA) and High Speed Uplink Package Access (HSUPA), to increase bandwidth utility rate and package data processing efficiency to improve uplink/downlink (UL/DL) transmission rate. HSDPA and HSUPA adopt Hybrid Automatic Repeat Request (HARQ) technology to enhance retransmission rate and reduce transmission delay. HARQ is a technology combining Feed-forward Error Correction (FEC) and ARQ methods, and uses a “Multi-channel Stop and Wait” algorithm, meaning that each channel decides to retransmit a packet or transmit the next packet according to positive/negative acknowledgement signals (ACK/NACK) reported by the receiver.

The LTE system can reach high transmission speed and large channel capacity under a limited frequency spectrum. Such operation requires high bandwidth utility rate. Therefore, the prior art has introduced MIMO into LTE, so as to multiply channel capacity without additional bandwidth or transmit power.

Due to MIMO, since transport blocks (data or control message) will be processed by different HARQ entities, the number of HARQ entities can be multiplied (depending on how many antennas). It means that each HARQ entity shall maintain its own transmission attributes (i.e. the Resource unit (RU) allocation, Modulation, coding and transport block size, and duration of the retransmission) being coincide or different, and HARQ operation may be affected based on what kind of MIMO mode it applies. In addition, the synchronous HARQ operation at Uplink is temporarily assumed while adaptive and asynchronous features are For Further Study (FFS).

On the other hand, in UL, due to the transport block characteristic, transmission resource and system load, transmission frequency, and importance and so on, it's expected that different MIMO mode would be utilized. This would determine different behavior at resource (grant) allocation by Scheduling Information (SI) messages, which are transmitted from the network, and utilized for indicating the granted transmission resources for UL transmission of user equipments (UEs). Moreover, in response to data transmission, transmission of control signaling may require different MIMO mode and resources as well as thus handling in various ways to provide necessary information. However, different MIMO modes are not permissibly used for different UEs simultaneously in UL multi-user MIMO (MU-MIMO).

### SUMMARY OF THE INVENTION

According to the present invention, a method for setting transmission grant of a MIMO UE in a network of a wireless communications system for uplink transmission is disclosed. The method comprises sending at least one control or configuration message corresponding to each HARQ entity of at least one HARQ entity or at least one HARQ process of an HARQ entity to the UE to set transmission grant of the UE when the UE performs uplink transmission through the at least one HARQ entity or the at least one HARQ process of the HARQ entity.

According to the present invention, a communications device for accurately setting transmission grant of a MIMO UE of a wireless communications system for uplink transmission is disclosed. The communications device comprises a control circuit for realizing functions of the communications device, a processor installed in the control circuit, for executing a program code to command the control circuit, and a memory installed in the control circuit and coupled to the processor for storing the program code. The program code comprises sending at least one control or configuration message corresponding to each HARQ entity of at least one HARQ entity or at least one HARQ process of an HARQ entity to the UE to set transmission grant of the UE when the UE performs uplink transmission through the at least one HARQ entity or the at least one HARQ process of the HARQ entity.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a function block diagram of a wireless communications device.

FIG. 2 is a diagram of program code of FIG. 1.

FIG. 3 is a flowchart of a process according to an embodiment of the present invention.

### DETAILED DESCRIPTION

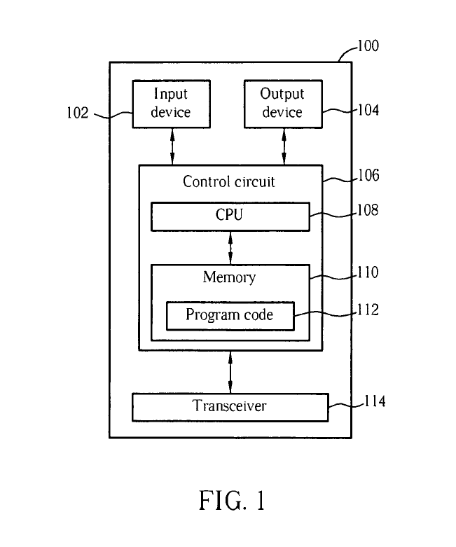

Please refer to FIG. 1, which is a functional block diagram of a communications device 100. For the sake of brevity, FIG. 1 only shows an input device 102, an output device 104, a control circuit 106, a central processing unit (CPU) 108, a memory 110, a program code 112, and a transceiver 114 of the communications device 100. In the communications device 100, the control circuit 106 executes the program code 112 in the memory 110 through the CPU 108, thereby controlling an operation of the communications device 100. The communications device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3. Preferably, the communications device 100 is utilized in a third generation (3G) mobile communications system.

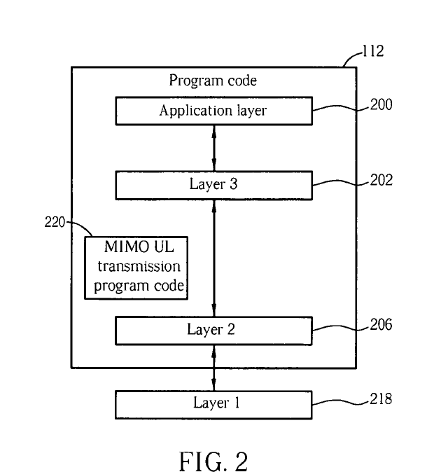

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. The Layer 3 202 performs resource control, the Layer 2 206 performs link control, and the Layer 1 218 performs physical connections.

As mentioned above, MIMO has been included in LTE, to multiply channel capacity without additional bandwidth or transmit power. In such case, the embodiment of the present invention provides a MIMO UL transmission program code 220 in the program code 112, utilized for realizing MIMO transmission in LTE.

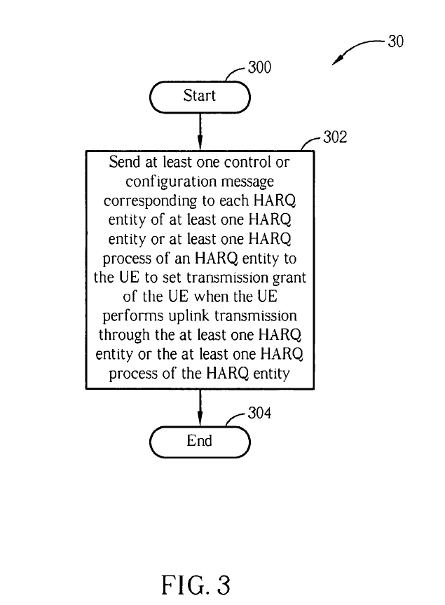

Please refer to FIG. 3, which illustrates a schematic diagram of a process 30. The process 30 is utilized for setting transmission grant of a MIMO UE in a network of a wireless communications system for uplink transmission. The process 30 can be compiled into the MIMO UL transmission program code 220, and comprises the following steps:
Step 300: Start.
Step 302: Send at least one control or configuration message corresponding to each HARQ entity of at least one HARQ entity or at least one HARQ process of an HARQ entity to the UE to set transmission grant of the UE when the UE performs uplink transmission through the at least one HARQ entity or the at least one HARQ process of the HARQ entity.
Step 304: End.

According to the process 30, when the UE performs uplink transmission through at least one HARQ entity or at least one HARQ process of an HARQ entity, the embodiment of the present invention sends at least one configuration message corresponding to each of the at least one HARQ entity or the at least one HARQ process of the HARQ entity to the UE, to set transmission grant of the UE.

Preferably, the at least one configuration message comprises at least one resource grant message. Moreover, the embodiment of the present invention can send the at least one control or configuration message or type indication signals of the at least one control or configuration message through at least one serving cell in a shared channel. Or, the embodiment of the present invention can send the at least one control or configuration message through at least one non-serving cell in a shared channel or a separate channel, such as a dedicated channel.

If an HARQ entity can include a specified number of HARQ processes, the number of HARQ entities should be increased as transmission capability changes, to meet the parallel operation. Oppositely, if a plurality of transmissions are allowed in an HARQ entity, then a plurality of HARQ entities are unnecessary. That is, as long as at least one HARQ process can be handled in a TTI, one or more HARQ entities are permissible.

Furthermore, preferably, before sending the at least one control or configuration message, the embodiment of the present invention can configure at least one UE within any mode to operate in the same reception configuration for the at least one control or configuration message. The at least one control or configuration message can be sent separately or in a same transport block or according to a MIMO mode of the UE. The MIMO mode is configured dynamically or predefined. Each of the at least one control or configuration message can be the same or different, and sent with the same size or different size of transport blocks.

In summary, the embodiment of the present invention sends at least one control or configuration message to the UE when the UE performs uplink transmission, so as to set transmission grant of the UE. Therefore, via the embodiment of the present invention, the MIMO UE can accurately perform UL transmission.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for setting transmission grant of a multi-input multi-output user equipment, called MIMO UE hereinafter, in a network of a wireless communications system for uplink transmission, the method comprising:
sending at least one control or configuration message corresponding to each HARQ entity of at least one HARQ entity or at least one HARQ process of an HARQ entity to the UE to set transmission grant of the UE when the UE performs uplink transmission through the at least one HARQ entity or the at least one HARQ process of the HARQ entity.

2. The method of claim 1, wherein the at least one control or configuration message comprises at least one resource grant message.

3. The method of claim 1, wherein sending the at least one control or configuration message is sending the at least one control or configuration message through at least one serving cell in a shared channel.

4. The method of claim 3 further comprising sending type indication signals of the at least one control or configuration message through the shared channel according to different configurations.

5. The method of claim 1, wherein sending the at least one control or configuration message is sending the at least one control or configuration message through at least one non-serving cell in a shared channel or a separate channel.

6. The method of claim 5, wherein the separate channel is a dedicated channel.

7. The method of claim 1 further comprising configuring at least one UE within any mode to operate in the same reception configuration for the at least one control or configuration message before sending the at least one control or configuration message.

8. The method of claim 1, wherein the at least one control configuration message is corresponding to each of the at least one HARQ entity or the at least one HARQ process of the at least one HARQ entity, and at least one control or configuration message corresponding to the at least one control or configuration message are sent separately or in a same transport block.

9. The method of claim 1 further comprising sending the at least one control or configuration message according to a MIMO mode of the UE.

10. The method of claim 9, wherein the MIMO mode is configured dynamically or predefined.

11. The method of claim 1, wherein at least one control or configuration message of the at least one control or configuration message are the same or different.

12. The method of claim 1, wherein at least one control or configuration message of the at least one control or configuration message are sent with the same size or different size of transport blocks.

13. The method of claim 1, wherein the at least one control or configuration message are not sent explicitly based on timing, pilot signal, reception power ratio, scrambling sequence, operated frequency layer or bandwidth.

14. A communications device for accurately setting transmission grant of a multi-input multi-output user equipment, called MIMO UE hereinafter, of a wireless communications system for uplink transmission, the communications device comprising:
a control circuit for realizing functions of the communications device;
a processor installed in the control circuit, for executing a program code to command the control circuit; and
a memory installed in the control circuit and coupled to the processor for storing the program code;
wherein the program code comprises:
sending at least one control or configuration message corresponding to each HARQ entity of at least one HARQ entity or at least one HARQ process of an HARQ entity to the UE to set transmission grant of the UE when the UE performs uplink transmission through the at least one HARQ entity or the at least one HARQ process of the HARQ entity.

15. The communications device of claim 14, wherein the at least control or one configuration message comprises at least one resource grant message.

16. The communications device of claim 14, wherein sending the at least one control or configuration message is sending the at least one control or configuration message through at least one serving cell in a shared channel.

17. The communications device of claim 16, wherein the program code further comprises sending type indication signals of the at least one control or configuration message through the shared channel according to different configurations.

18. The communications device of claim 14, wherein sending the at least one control or configuration message is sending the at least one control or configuration message through at least one non-serving cell in a shared channel or a separate channel.

19. The communications device of claim 18, wherein the separate channel is a dedicated channel.

20. The communications device of claim 14, wherein the program code further comprises configuring at least one UE within any mode to operate in the same reception configuration for the at least one control or configuration message before sending the at least one control or configuration message.

21. The communications device of claim 14, wherein the at least one control or configuration message is corresponding to each of the at least one HARQ entity or the at least one HARQ process of the at least one HARQ entity, and at least one control or configuration message corresponding to the at least one control or configuration message are sent separately or in a same transport block.

22. The communications device of claim 14, wherein the program code further comprises sending the at least one control or configuration message according to a MIMO mode of the UE.

23. The communications device of claim 22, wherein the MIMO mode is configured dynamically or predefined.

24. The communications device of claim 14, wherein at least one control or configuration message of the at least one control or configuration message are the same or different.

25. The communications device of claim 14, wherein at least one control or configuration message of the at least one control or configuration message are sent with the same size or different size of transport blocks.
